(19) United States
(12) Patent Application Publication
(10) Pub. No.: US 2018/0312342 A1
(43) Pub. Date: Nov. 1, 2018

(54) AN APPARATUS FOR TRANSPORTING BLANKS AND A METHOD THEREOF

(71) Applicant: Tetra Laval Holdings & Finance S.A., Pully (CH)

(72) Inventor: Richard Persson, Häljarp (SE)

(21) Appl. No.: 15/737,767

(22) PCT Filed: Jun. 23, 2016
(86) PCT No.: PCT/EP2016/064586

§ 371 Date: Dec. 19, 2017

(30) Foreign Application Priority Data
Jun. 29, 2015 (SE) 1550899-7

(51) Int. Cl. B65G 25/02; B65H 1/02; B65B 43/14

(52) U.S. Cl. CPC B65G 25/02; B65H 1/025; B65H 3/56; B65H 2403/514; B65H 2701/1764; B65B 43/145

(57) ABSTRACT

It is provided a method for transporting blanks. In a first step the method comprises placing said blanks in a magazine (100), wherein the magazine (100) comprises a first bar (106a, 106f) and a second bar (106b, 106e), said first bar (106a, 106f) being moveable in a first direction being substantially horizontal and coinciding with a transport direction and a second direction being substantially vertical. In a second step the method comprises moving said first bar (106a, 106f) such that said blanks are moved in said transport direction and such that said blanks are alternately placed on said first bar (106a, 106f) and said second bar (106b, 106e).

### TECHNICAL FIELD

The subject matter of this patent application generally relates to the field of packaging. More particularly, it relates to how to efficiently transport blanks in a magazine.

### BACKGROUND OF THE INVENTION

A common type of carton packaging machine is a so-called blank fed packaging machine. In short, the main steps for such a machine is to receive a sleeve-shaped blank, i.e. a sleeve shaped packaging material piece folded planar, erect the sleeve-shaped blank into a sleeve, seal one end of the sleeve such that a one end open package is formed, fill said package with product and seal the other end of the package such that a closed package is formed. There are many variants of these steps and different techniques for doing these steps.

One challenge with packaging machines like this is how to efficiently and securely feed the sleeve-shaped blanks to the machines. For instance, if not done properly the sleeve-shaped blanks may attach to each other, which causes problems when they should be moved from the magazine to the packaging machine one by one. Another problem is that one inner side of the sleeve-shaped blank can attach to another inner side of the sleeve-shaped blank when being transported in the magazine. This causes problem when erecting the sleeve-shaped blank at a later stage.

Similar problems arise for magazines in e.g. card board packers. In these magazines blanks, being pieces of cardboard packaging material with creasing lines to be folded into a cardboard box, are stored and fed to an apparatus folding a box of the blank and filling said box with for instance juice packages.

Therefore, in order to provide for that blank fed packaging machines, both machines using sleeve-shaped blanks as well as machines using blanks being a cut out piece of material, can operate efficiently there is a need to make sure that the above mentioned problems are avoided or mitigated.

### SUMMARY

Accordingly, the present invention preferably seeks to mitigate, alleviate or eliminate one or more of the above-identified deficiencies in the art and disadvantages singly or in any combination and solves at least the above mentioned problems e.g. by providing

According to a first aspect it is provided a method for transporting blanks, said method comprising placing said blanks in a magazine, said magazine comprising a first bar and a second bar, said first bar being moveable in a first vertical plane, and moving said first bar such that said blanks are moved in a transport direction and such that said blanks are alternately placed on said first bar and said second bar.

The magazine may further comprise a third bar, wherein said third bar is moveable in a third vertical plane, said third vertical plane being parallel with said first vertical plane, wherein said third bar is arranged to be moved aligned with said first bar, said method further comprises moving said third bar such that said blanks are moved in said transport direction and such that said blanks are alternately placed on said first and third bars and said second bar.

The second bar may be moveable in a second vertical plane, said second vertical plane being parallel with said first vertical plane, wherein said second bar is arranged to be moved offset in relation to said first bar, said method further comprises moving said second bar such that said blanks are moved in said transport direction and such that said blanks are alternately placed on said first bar and said second bar.

The magazine may further comprise a fourth bar, wherein said fourth bar is moveable in a fourth vertical plane, said fourth vertical plane being parallel with said first vertical plane, wherein said fourth bar is arranged to be moved aligned with said second bar, said method further comprises moving said fourth bar such that said blanks are moved in said transport direction and such that said blanks are alternately placed on said first and third bars and said second and fourth bars.

The first and third bars may be placed next to each other and said second and fourth bars are placed with said first and third bars placed between them.

The first bar may be eccentrically connected to a first rotating shaft in a first point of said first bar.

The first bar may be eccentrically connected to a second rotating shaft in a second point of said first bar, wherein a first connection in said first point and a second connection in said second point are rotationally aligned.

The second bar may be eccentrically connected to said first rotating shaft in a first point of said second bar, wherein said first connection in said first point of said first bar and said first connection of said first point of said second bar are rotationally offset.

The second bar may be a fixed bar, and wherein said first bar is arranged to be placed above said second bar during a first part of a first bar movement cycle and below said second bar during a second part of said first bar movement.

According to a second aspect it is provided an arrangement for transporting blanks, said arrangement comprising a first bar and a second bar for said blanks to be placed on, said first bar being moveable in a first vertical plane such that when said first bar is moved said blanks are moved in a transport direction and said blanks are alternately placed on said first bar and said second bar.

The magazine may further comprise a third bar, wherein said third bar is moveable in a third vertical plane, said third vertical plane being parallel with said first vertical plane, wherein said third bar is arranged to be moved aligned with said first bar.

The second bar may be moveable in a second vertical plane, said second vertical plane being parallel with said first vertical plane, wherein said second bar may be arranged to be moved offset in relation to said first bar.

The magazine may further comprise a fourth bar, wherein said fourth bar is moveable in a fourth vertical plane, said fourth vertical plane being parallel with said first vertical plane, wherein said fourth bar is arranged to be moved aligned with said second bar, said method further comprises moving said fourth bar such that said blanks are moved in said transport direction and such that said blanks are alternately placed on said first and third bars and said second and fourth bars.

The first and third bars may be placed next to each other and said second and fourth bars are placed with said first and third bars placed between them.

The second bar may be a fixed bar, and wherein said first bar may be arranged to be placed above said second bar during a first part of a first bar movement cycle and below said second bar during a second part of said first bar movement.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, wherein:

FIG. 1 illustrates a magazine for holding and successively feeding blanks to a packaging machine.

FIG. 2 illustrates a cross section of a first rotating shaft attached to a number of bars of said magazine.

FIG. 3 illustrates the bars and rotating shafts of said magazine.

FIGS. 4a and 4b illustrate an example of how blanks are transported using three moving bars.

FIG. 5 illustrates a flowchart including a number of steps for illustrating a method for transporting blanks.

### DETAILED DESCRIPTION

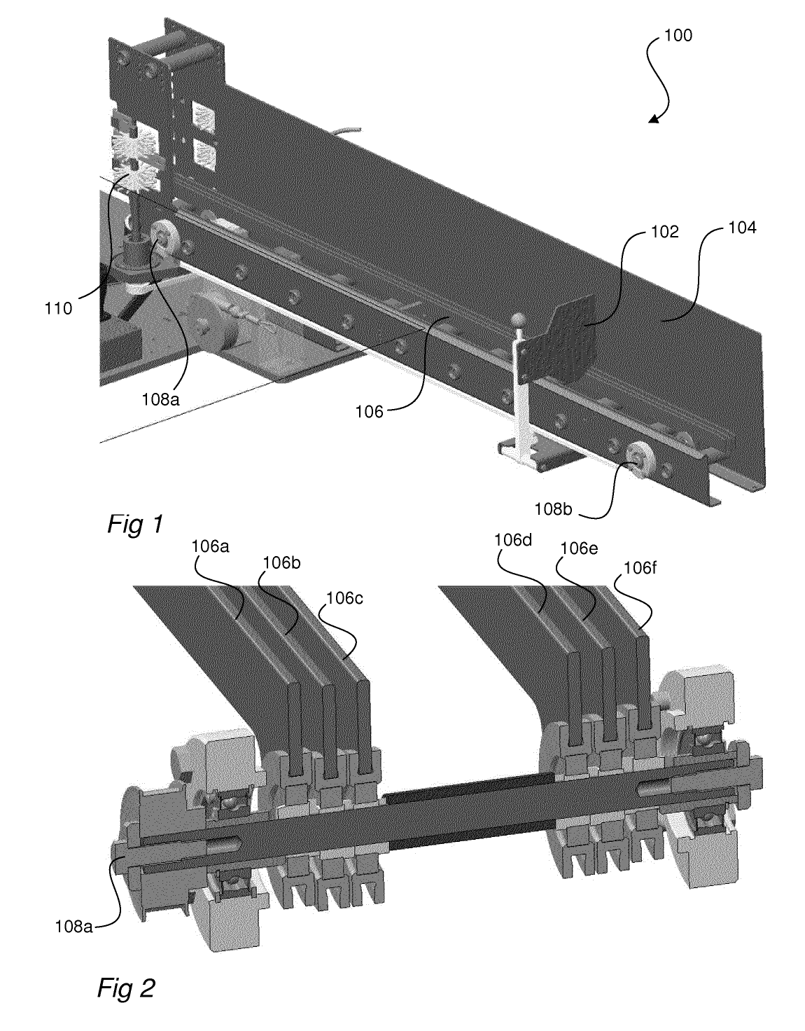

FIG. 1 illustrates an example of a magazine 100 that can be used for holding and feeding blanks, more particularly sleeve shaped packaging material pieces folded planar. In this particular magazine the blanks are placed with one open end faced upwards and another open end faced downwards. In order to keep the last blanks in the magazine in place a blank holder 102 can be used, and in order to provide for that the blanks are kept in place sideways one or two side cover plates 104 can be used. For illustrative purposes, only one side cover plate 104 is illustrated.

The blanks are placed on a number of bars 106. The bars are in this example eccentrically connected to a first and a second rotating shaft 108a, 108b such that each of the bars can be moved in a rotational movement. Since there are a number of bars and since some of their connections are rotationally offset, the design provides for that blanks are transported by one bar a short distance before another bar is taking over. This principle is further illustrated in FIGS. 4a and 4b.

In order to provide for that the blanks are held stable a number of pairs of bars can be formed. Each pair have eccentrical connections that are rotationally aligned such their movements are aligned, and are placed at a distance from each other such that the blank will be able to rest safely on two bars forming a pair.

FIG. 2 illustrates a cross section of the first rotational shaft 108a and six bars 106a,b,c,d,e,f eccentrically connected thereto. A first pair is formed by the two outer bars 106a and 106f, a second pair is formed by the two bars placed in the middle of the two groups 106b and 106e, and a third pair is formed by the two inner bars 106c and 106d. By having the pairs formed in this way a movement of the blanks sideways can be avoided or at least reduced, i.e. a movement perpendicular to an intended transport direction.

In an alternative embodiment, different from the embodiments illustrated, pairs of bars may be arranged such that the blanks waddle forward while being transported. An advantage of this is that the risk that the blanks stick to each other is reduced, which may be advantagous if e.g. using a packaging material that is prone to stick.

Returning to FIG. 1, brushes 110 may be provided in order to reduce the risk that the blanks attach to one another. In this example the brushes are provided in an end of the magazine such that the blanks can be separated before they are gripped individually.

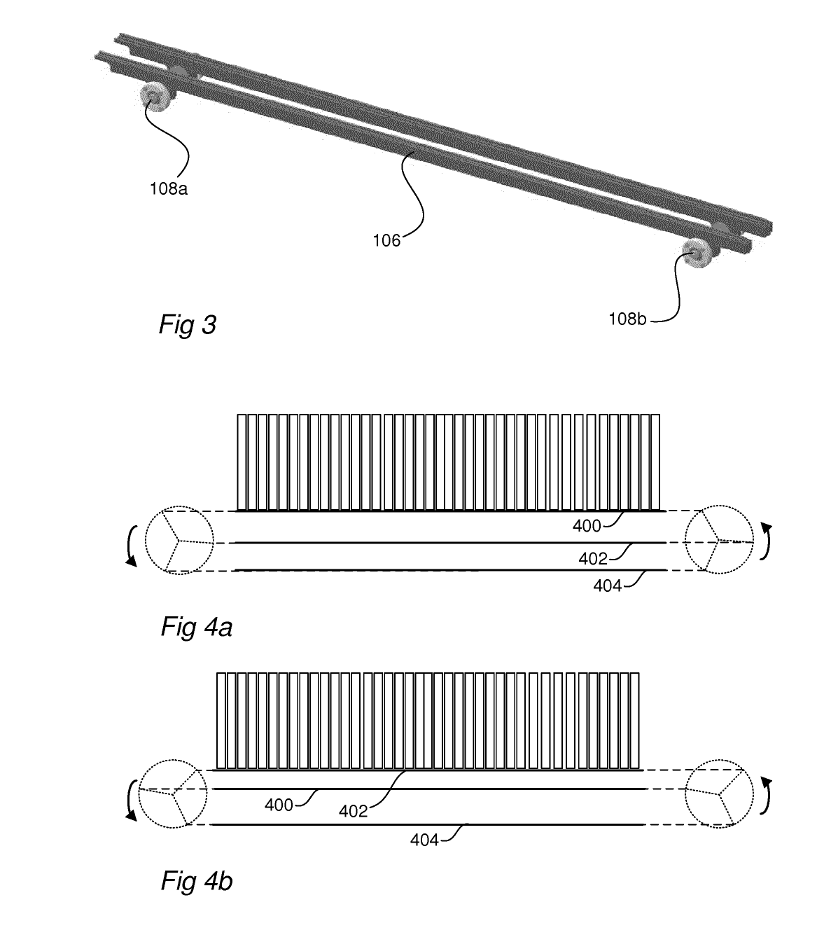

In order to provide for easy installation and service, the bars can be placed on bar holding elements on the rotational shafts. In order to provide for that the bars do not move sideways the bar holding elements may be provided with side walls preventing this, as illustrated in FIG. 2. In order to provide for that the bar is held in place in the transportation direction it can be provided with two pins placed on either side of the bar holding element. This is illustrated in FIG. 3 in which the bars 106 and the first and second rotational shafts 108a, 108b are illustrated in isolation.

FIGS. 4a and 4b illustrate the principle on how blanks can be transported using a number of bars as by example illustrated in FIG. 3. More specifically, in FIGS. 4a and 4b three bars are rotationally offset 120 degrees from each other and attached to rotating shafts or other rotating device. In FIG. 4a the blanks are resting on a first bar 400, or a first group of bars as explained above, while in FIG. 4b, illustrating a situation after the situation illustrated in FIG. 4a, a second bar 402 has taken over role of the first bar 400 of being the most upper placed bar and hence, as an effect, the blanks are now resting on the second bar 402. A third bar 404 has been moved from one position to another position, but is in both illustrated situations the most lower placed bar. In a later stage though, after the situation illustrated in FIG. 4b, this bar will take over the role of being the most upper placed bar from the second bar 402.

An advantage of having three bars, or three groups of rotationally aligned bars, is that when having the blanks shifted from resting on one bar to another a velocity in a transport direction is not zero, which is the case if having two bars rotationally offset by 180 degrees. Having a velocity in the transport direction when shifting has the positive effect that the transportation of the blanks are made more gentle.

Still an advantage, linked to that the blanks are transported by the bars they are resting on instead of having them pushed forward from behind, is that packaging material having a higher likelihood for sticking can be used. Having a greater flexibility in terms of packaging material means in turn that more cost efficient packages can be made.

Even though not illustrated one or several moving bars can be combined with a fixed bar, or a group of vertically aligned fixed bars. With such a set up the blanks will be transported when resting on the moving bars and standing still when being placed on the fixed bar. Put differently, the fixed bar will not transport the blanks, but serves the purpose of preventing the blanks from being transported backwards by the moving bar.

Further, also not illustrated, one end of the moving bar, or moving bars, can be connected in a first point to a fixed pin, and not to a rotational shaft, while the other end of the moving bar, or moving bars, may be connected to a rotating shaft or other rotating device in a second point. The first point may be placed in a front part of a magazine, or similar, and the second point may be placed in a rear part of the magazine. The first point may be placed vertically below the second point. With a set up like this the blanks can be fed forward by the bars in the rear part of the magazine, but not in the front part. However, due to that the blanks are fed forward in the rear part this will also have an effect of the blanks in the front part. Having the first point placed lower than the second point, gravity will further help feeding the blanks forward.

As can be understood by the skilled persons a number of different combinations of moving bars and fixed bars are available and only a few are mentioned here as examples.

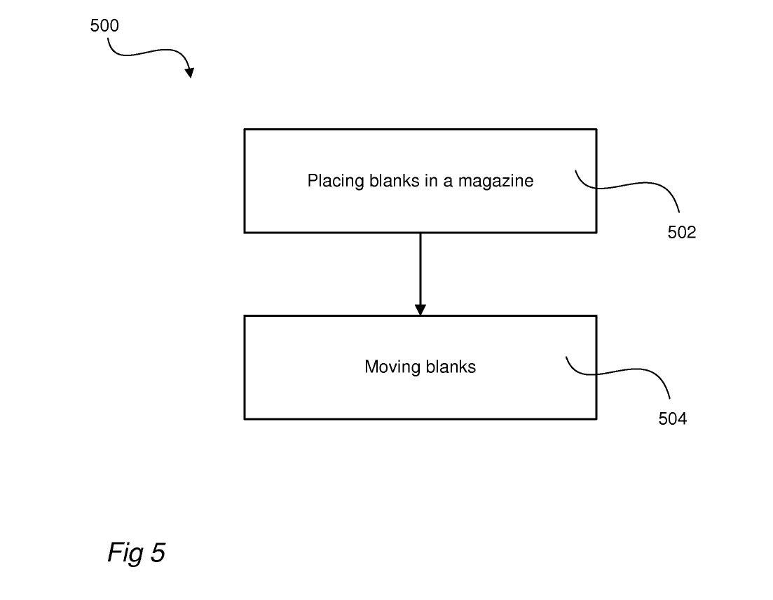

FIG. 5 illustrates a flow chart 500 illustrating a method for transporting blanks. The method comprises in a first step 502 in which the blanks are placed in the magazine. The magazine can comprise a first bar and a second bar, wherein the first bar is moveable in a first vertical plane.

In a second step 504 the first bar is moved such that the blanks are moved in the transport direction and such that the blanks are alternately resting on said first bar and said second bar.

The second bar may be a fixed bar. By having the first bar moving e.g. in a circular movement in said first vertical plane and having the second bar placed such that this is above the first bar during a part of this movement, the blanks can be moved by the first bar when this is placed above the second bar towards an end of the magazine and when the first bar is placed under the second bar the blanks are resting on the second bar.

Alternatively, the first and second bar may both be moveable. Further, there may be provided more than two bars, as illustrated in FIGS. 1, 2 and 3.

The term packaging machine should be given a broad meaning and include any machine handling blanks that may face any of the problems mentioned, e.g. liquid food packaging machines or secondary packaging machines.

The subject matter has mainly been described above with reference to a few embodiments. However, as is readily appreciated by a person skilled in the art, other embodiments than the ones disclosed above are equally possible within the scope of the invention, as defined by the appended patent claims.

1. A method for transporting blanks, said method comprising:
placing said blanks in a magazine, said magazine comprising a first bar and a second bar, said first bar being moveable in a first vertical plane, and
moving said first bar such that said blanks are moved in a transport direction and such that said blanks are alternately placed on said first bar and said second bar.

2. The method according to claim 1, wherein said magazine further comprises a third bar, wherein said third bar is moveable in a third vertical plane, said third vertical plane being parallel with said first vertical plane, wherein said third bar is arranged to be moved aligned with said first bar, said method further comprises:
moving said third bar such that said blanks are moved in said transport direction and such that said blanks are alternately placed on said first and third bars and said second bar.

3. The method according to claim 1, wherein said second bar is moveable in a second vertical plane, said second vertical plane being parallel with said first vertical plane, wherein said second bar is arranged to be moved offset in relation to said first bar, said method further comprises:
moving said second bar such that said blanks are moved in said transport direction and such that said blanks are alternately placed on said first bar and said second bar.

4. The method according to claim 3, wherein said magazine further comprises a fourth bar, wherein said fourth bar is moveable in a fourth vertical plane, said fourth vertical plane being parallel with said first vertical plane, wherein said fourth bar is arranged to be moved aligned with said second bar, said method further comprises:
moving said fourth bar such that said blanks are moved in said transport direction and such that said blanks are alternately placed on said first and third bars and said second and fourth bars.

5. The method according to claim 4, wherein said first and third bars are placed next to each other and said second and fourth bars are placed with said first and third bars placed between them.

6. The method according to claim 1, wherein said first bar is eccentrically connected to a first rotating shaft in a first point of said first bar.

7. The method according to claim 6, wherein said first bar is eccentrically connected to a second rotating shaft in a second point of said first bar, wherein a first connection in said first point and a second connection in said second point are rotationally aligned.

8. The method according to claim 6, wherein said second bar is eccentrically connected to said first rotating shaft in a first point of said second bar, wherein said first connection in said first point of said first bar and said first connection of said first point of said second bar are rotationally offset.

9. The method according to claim 1, wherein said second bar is a fixed bar, and wherein said first bar is arranged to be placed above said second bar during a first part of a first bar movement cycle and below said second bar during a second part of said first bar movement.

10. An arrangement for transporting blanks, said arrangement comprising:
a first bar and a second bar for said blanks to be placed on,
said first bar being moveable in a first vertical plane such that when said first bar is moved said blanks are moved in a transport direction and said blanks are alternately placed on said first bar and said second bar.

11. The arrangement according to claim 10, wherein said magazine further comprises a third bar, wherein said third bar is moveable in a third vertical plane, said third vertical plane being parallel with said first vertical plane, wherein said third bar is arranged to be moved aligned with said first bar.

12. The arrangement according to claim 10, wherein said second bar is moveable in a second vertical plane, said second vertical plane being parallel with said first vertical plane, wherein said second bar is arranged to be moved offset in relation to said first bar.

13. The arrangement according to claim 12, wherein said magazine further comprises a fourth bar, wherein said fourth bar is moveable in a fourth vertical plane, said fourth vertical plane being parallel with said first vertical plane, wherein said fourth bar is arranged to be moved aligned with said second bar, said method further comprises:
moving said fourth bar such that said blanks are moved in said transport direction and such that said blanks are alternately placed on said first and third bars and said second and fourth bars.

14. The arrangement according to claim 13, wherein said first and third bars are placed next to each other and said second and fourth bars are placed with said first and third bars placed between them.

15. The arrangement according to claim 10, wherein said second bar is a fixed bar, and wherein said first bar is arranged to be placed above said second bar during a first part of a first bar movement cycle and below said second bar during a second part of said first bar movement.
